(19) United States
(12) Patent Application Publication
(10) Pub. No.: US 2004/0146242 A1
(43) Pub. Date: Jul. 29, 2004

(54) Method and structure for coupling light in and out of an inplane waveguide through the top and bottom surfaces of photonic crystals

(76) Inventors: Mihail M. Sigalas, Santa Clara, CA (US); Jeremy A. Theil, Mountain View, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/354,796

(22) Filed: Jan. 29, 2003

(51) Int. Cl. G02B 6/26

(52) U.S. Cl. 385/31; 385/48

(57) ABSTRACT

An add drop filter utilizing a three dimensional photonic crystal structure for WDM applications is disclosed. Electromagnetic radiation at specific frequencies may be extracted (drop feature) from or inserted (add feature) into an in-plane waveguide from the top or bottom of a layer-by-layer photonic crystal structure by coupling the light through one or more defects

### FIELD OF INVENTION

The invention relates generally to the area of photonic crystals and specifically to add/drop structures.

### BACKGROUND OF THE INVENTION

For optical communications it is desirable to have wavelength division multiplexing (WDM) configurations utilizing compact add-drop filters.

In some prior art configurations, light propagates through conventional high dielectric waveguides and the coupling between waveguides is performed using micro-rings. Because the propagation is through high dielectric material, the internal losses and dispersion due to the high dielectric material may critically impact performance. This problem increases as the transmitted power increases.

In other prior art configurations, waveguides are created in two-dimensional photonic crystals of very long dielectric rods. Coupling between waveguides is performed using cavities. These photonic crystals are difficult to fabricate for operation at optical communications wavelengths. In two-dimensional photonic crystals with shorter dielectric rods there are confinement problems for light along the rod axis direction. Additionally, the photonic band gap occurs in only one polarization so the configurations are inherently multimode.

### SUMMARY OF THE INVENTION

In accordance with the invention, wavelength division multiplexing (WDM) configurations in three dimensional layer by layer photonic crystal structures have been developed. These three dimensional photonic crystals may be made by stacking dielectric rods layer by layer such as shown in FIG. 1. Electromagnetic radiation at specific frequencies may be extracted (drop feature) from or inserted (add feature) into an in-plane waveguide from the top or bottom of a layer-by-layer photonic crystal structure by coupling the electromagnetic radiation through one or more defects, typically cavities, arranged in the stacking direction. The operating wavelength of the device depends on the size of the cavities. The electromagnetic radiation is confined in the low dielectric region of the photonic crystal structure making the effects of internal losses and dispersion of the high refractive index medium less important. The waveguides and defects may be made single mode which is not possible with two dimensional photonic crystals.

### BRIEF DESCRIPTION OF THE DRAWINGS

FIG. 1 shows an embodiment of a photonic crystal structure in accordance with the invention.

FIG. 2 shows the projection of a photonic crystal structure in accordance with the invention into the layer plane.

FIG. 3 shows a side view of the photonic crystal structure in FIG. 2.

FIG. 4 shows the transmitted power at the ports of the photonic crystal structure shown in FIG. 3 in accordance with the invention.

FIG. 5 shows the projection of a photonic crystal structure in accordance with the invention into the layer plane.

FIG. 6 shows a side view of the photonic crystal structure in FIG. 5.

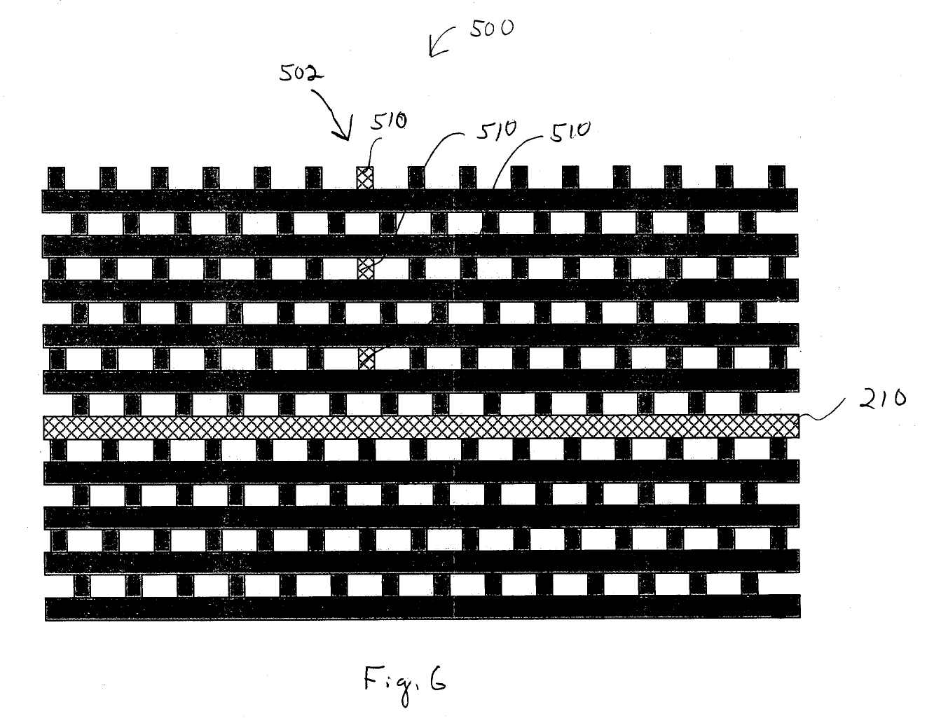

FIG. 7 shows the transmitted power at the ports of the photonic crystal structure shown of FIG. 6 in accordance with the invention.

### DETAILED DESCRIPTION OF THE INVENTION

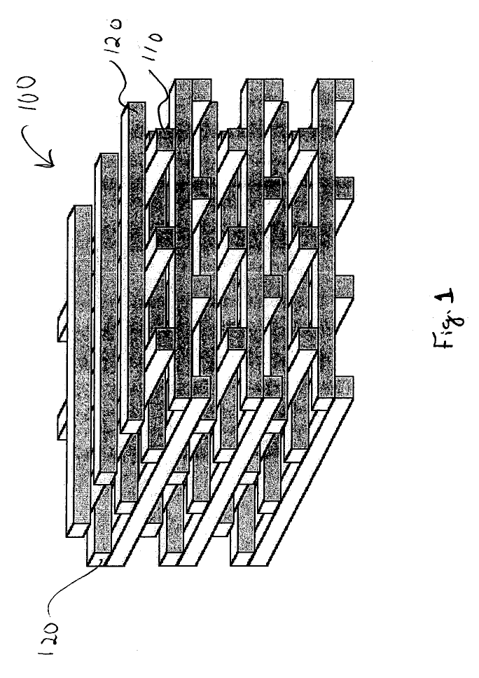

FIG. 1 shows three-dimensional photonic crystal structure 100 in accordance with the invention. Photonic crystal structure 100 is made of dielectric rods 110 and 120 stacked together and the low dielectric material is typically air. Typically, rods 110 in a given layer are arrayed substantially perpendicular to rods 120 in the two neighboring layers and separated within the layer by a distance a which is the lattice constant. In an exemplary embodiment in accordance with the invention, lattice constant, a ≈11 mm, rods 110 and 120 typically have a dielectric constant of about 9.61 and are made of alumina (Al₂O₃), with a length of about 15 cm and a square cross-sectional width of about 3.2 mm.

Photonic crystal structure 100 is typically 14 by 14 by 5 unit cells in size. Each unit cell of photonic crystal structure 100 is about 11 mm by 11 mm by 12.8 mm in size. For the exemplary embodiment, there is a full photonic band gap between about 11.2 and 12.9 GHz. Any other combination of lattice constant, number of unit cells, width of dielectric rods and dielectric constant provides results in accordance with the invention if a full photonic band gap exists. For a photonic band gap to exist, the refractive index contrast between the dielectrics, for example air and alumina, should be greater than about 2.5. Additionally for existence of a photonic band gap, the ratio of the vertical spacing, c, of the unit cells to the lattice constant, a, or c/a should be about 1.2 and the fill ratio for the higher refractive index material, for example alumina, should be about 0.3. Further details may be found in U.S. Pat. Nos. 5,335,240 and 5,406,573 incorporated by reference. Note that results scale with the lattice constant a. Decreasing the lattice constant a decreases the operating wavelength of photonic crystal structure 100 so photonic crystal structure 100 may be scaled, for example, to operate in the 200 THz region of optical communications.

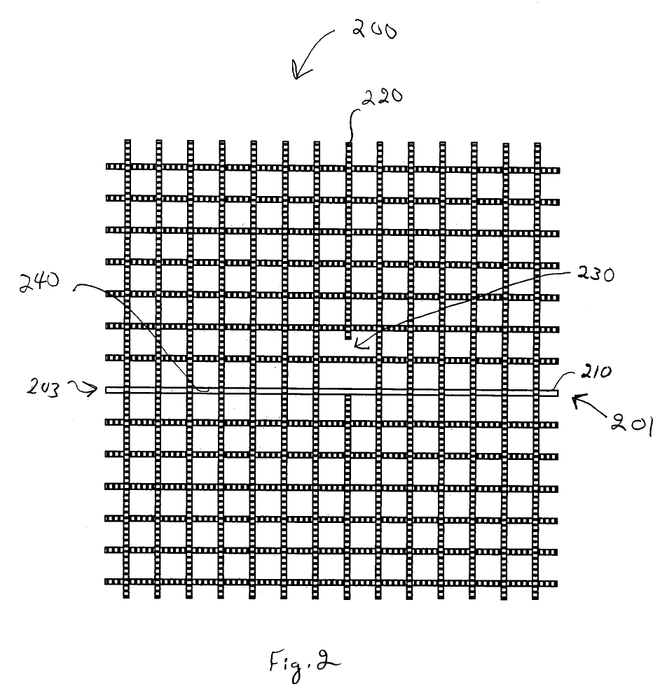

In accordance with the invention, waveguides and cavities may be created in photonic crystal structure 100 by removing single dielectric rod 110 or part of dielectric rod 110, respectively, to create an add-drop filter. Add-drop filters may be used to selectively add or drop electromagnetic radiation at various frequencies from or to optical communication traffic. FIG. 2 shows a simplified projection in the xy plane of the 9^{th}, 12^{th}, 16^{th} and 20^{th} layers for photonic crystal structure 200 with waveguide 240 and cavity 230. One rod 210 is absent from the 9^{th} layer to form waveguide 240 and a portion (about 1.5 unit cell) of one rod 220 is absent from each of 12^{th}, 16^{th} and 20^{th} layers to form cavities 230. In other embodiments only one cavity may be used to make an add-drop filter in accordance with the invention. In accordance with the invention, waveguide 240 could also be formed by thinning rod 210 in the 9^{th} layer instead. Thinning rod 210 results in an increase in the frequency width of the waveguide band. Also, waveguide 240 could be formed in a direction transverse to rods 210 in the 9^{th} layer by removing a collinear portion in each of rods 210 in the 9^{th} layer, the absent portion typically having the cross-section of rod 210. In place of using cavities 230 as defects by removing portions of rods 220 in the 12^{th}, 16^{th} and 20^{th} layers, the portions of rods 220 in the respective layers could be thinned to create defects at the appropriate place instead.

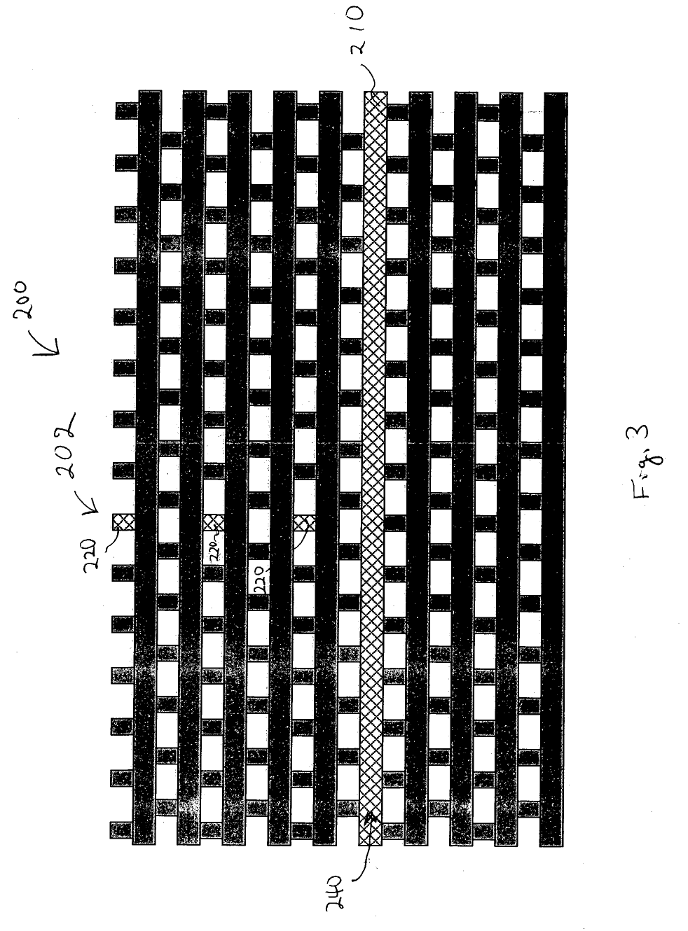

FIG. 3 shows a side view of photonic crystal structure 200 in accordance with the invention showing the location of partial rods 220, the location of absent rod 210 which gives waveguide 240. In general, waveguides and cavities may be created in accordance with the invention by replacing dielectric rods 110 and 120 in FIG. 1 with narrower or wider rods. However, such configurations may be less favorable than the configuration shown in FIG. 2 due to the possible presence of absorption or non-linear features in the dielectric. For example, impurities in silicon will lead to absorption. Waveguide 240 and cavities 230 may be formed in different layers from those shown in, for example, FIG. 2.

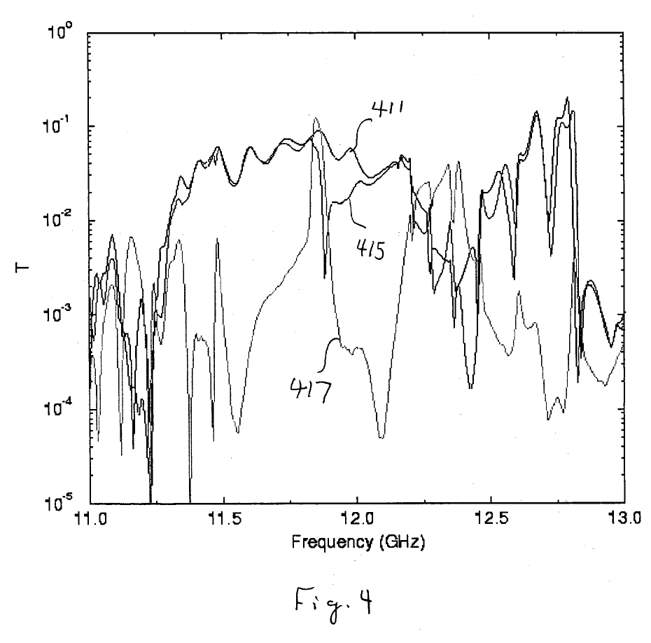

Photonic crystal structure 100 in the periodic case has a photonic band gap between 11.2 and 13.1 Ghz for waves propagating along the x direction with the electric field in the z direction. Transmission drops by four orders of magnitude within most of the band gap region. Removal of one rod 210 in the 9^{th} layer creates a waveguide band between 11.3 and 12.7 GHz covering most of the photonic band gap region as shown in FIG. 4 by line 411. The sharp notches and peaks in line 411 above 12 GHz are due to imperfections and locations of the band gaps in exemplary photonic crystal structure 200. For photonic crystal structure 100, rods 110 were assembled with adhesive and the alignment was imperfect.

The transmission received at port 201 (on the right side of FIG. 2) is represented by line 415 in FIG. 4. When operated in a drop configuration, transmission at port 201 shows a sharp notch, corresponding to the frequency dropped, at about 11.86 Ghz with a Q-factor of about 1320. The transmission received at port 202 showing the frequency extracted (see FIG. 3) is represented by line 417 and shows a sharp peak at about 11.86 GHz with a Q-factor of about 395. When photonic crystal structure 100 is used in an add configuration, the transmitter is typically located at port 202 and receiver or receivers are typically located at the ends of waveguide 240 such as ports 201 and 203.

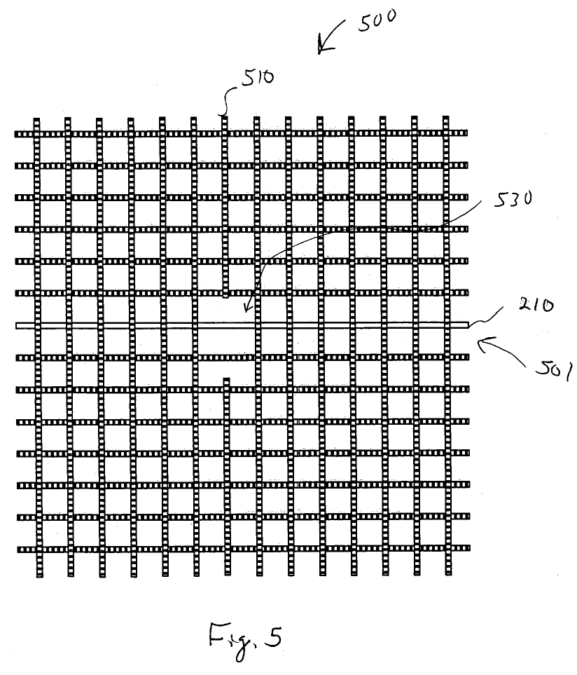

For a single defect (no waveguide or additional defects present) the Q-factor depends on the number of unit cells surrounding the defect. The more unit cells surrounding the defect the higher the Q-factor. When a waveguide and numerous defects are present the analysis is more complicated but the basic concept is the same. Multiple defects of different sizes and separated by several unit cells to minimize interference provides more than one resonance allowing additional add/drop frequencies. For example, a combination of the defects shown in FIGS. 2 and 5 may be used as an embodiment in accordance with the invention. Hence, the 12^{th}, 16^{th} and 20^{th} layers would include two types of defects separated by at least two unit cells to avoid interference effects. This embodiment has two resonant frequencies at about 11.67 and 11.86 GHz which correspond to the resonant frequencies of the two types of defects. The distance between the cavity and the waveguide as well as the size of the photonic crystal determine output power. The size of the photonic crystal relates to how many unit cells surround the cavity.

The operating frequency of photonic crystal structure 200 may be modified by changing the size of the cavities. FIG. 5 shows a simplified projection in the xy plane of the 9^{th}, 12^{th}, 16^{th} and 20^{th} layers for photonic crystal structure 500 with waveguide 540 and cavities 530. One rod 210 is absent from the 9^{th} layer and a 2.25 unit cell portion of rod 510 is absent from each of the 12^{th}, 16^{th} and 20^{th} layers to create defects. Typically, as the size of the defect is increased the resonance moves from the lower edge of the photonic band gap to the upper edge of the photonic band gap. As the size of the defect is increased further, an additional resonance or resonances may appear at the lower edge of the photonic band gap. Alternatively, thickening a rod and thereby increasing the amount of higher dielectric material causes a resonance to appear at the upper edge of the photonic band gap and moves towards the lower edge of the photonic band gap as the amount of the higher dielectric material is increased.

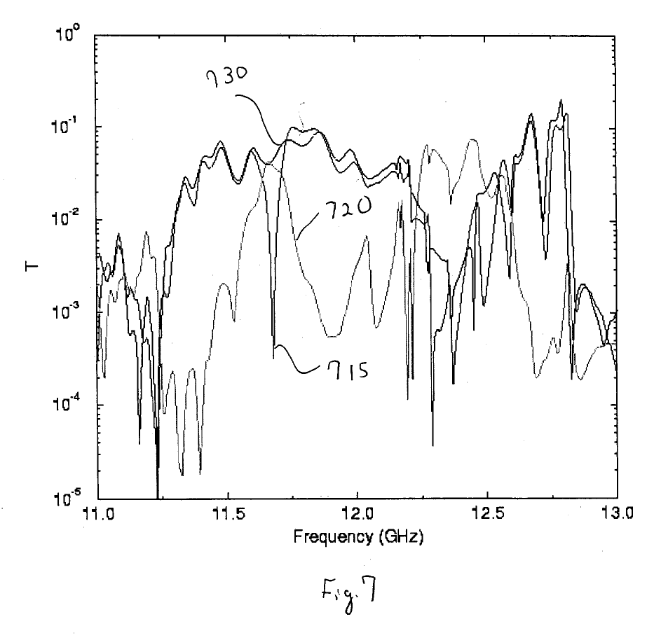

The transmission at port 501 (on the right side of FIG. 5) is represented by line 715 and the transmission at port 502 is represented by line 720 in FIG. 7. Line 715 shows a sharp notch at about 11.67 GHz while line 720 shows a sharp peak at about 11.67 GHz. The Q-factor at port 501 is about 1882 and at port 502 is about 120.

The examples in accordance with the invention shown in FIGS. 4 and 7 have the electric field oriented along the z axis. Only waves with the electric field oriented along the z axis have propagating modes in photonic crystal structures 200 and 500 due to the lattice asymmetry. Rotating the electric field by 90 degrees causes a drop in transmitted power by several orders of magnitude. Limiting propagation to a single mode avoids the mixing of polarizations that typically occurs in two dimensional slab photonic crystal waveguides.

For photonic crystal structures 200 and 500 to operate in the communications wavelength range in the vicinity of 1.5 μm, photonic crystal structures 200 and 500 need to be constructed at the sub-micron level. Techniques for sub-micron construction exist in advanced CMOS integrated circuit fabrication process flow similar to that disclosed by Lin and Fleming, “A Three-Dimensional Optical Photonic Crystal” in Journal of Lightwave Technology 17, 1944, 1999 using polysilicon rods. Alternatively, a process flow using plasma enhanced chemical vapor deposition (PECVD) to make rod structures from a-Si:H films may be used. Use of PECVD allows low processing temperatures that permit the integration of back-end of the line (BEOL) interconnect or III-V substrates as described in U.S. patent application Ser. No. 10/293,995 (Attorney Docket No. 10020077) and incorporated herein by reference.

Fabrication of sub-micron structures requires lithographic techniques capable of resolving features on the order of 0.2 μm during patterning. A typical lithographic technique is deep ultraviolet lithography and direct writing may also be used. Typical feature enhancement techniques that may be applied in accordance with the invention include phase-shift masking and optical proximity correction (OPC). It is typically important that the size of the vertically aligned cavities be well defined. If cavities with substantially different sizes, for example, a 20 percent variation, are used, multiple resonances or even broadened resonances may appear. This requires that the end of the rod at the cavity edge be precisely positioned which is typically accomplished using OPC.

While the invention has been described in conjunction with specific embodiments, it is evident to those skilled in the art that many alternatives, modifications, and variations will be apparent in light of the foregoing description. Accordingly, the invention is intended to embrace all other such alternatives, modifications, and variations that fall within the spirit and scope of the appended claims.

1. A three dimensional photonic crystal structure for coupling electromagnetic radiation in or out of a waveguide comprising:
a waveguide passing in a first direction through said three dimensional photonic crystal structure; and
at least one defect arranged in a second direction substantially perpendicular to said first direction such that said at least one defect is electromagnetically coupled to said waveguide.

2. The structure of claim 1 wherein electromagnetic radiation at substantially one frequency is coupled out of said waveguide.

3. The structure of claim 1 wherein said at least one defect is a cavity.

4. A photonic crystal structure with a photonic band gap comprising:
a plurality of dielectric rods with a first refractive index arranged in a matrix of a material with a second refractive index, said plurality of dielectric rods being arranged to form planar layers, said planar layers being stacked one on the other in a stacking direction to form a three-dimensional structure having a surface in said stacking direction, one of said planar layers comprising a waveguide, said waveguide being electromagnetically coupled to said surface by one or more defects arranged in said stacking direction.

5. The structure of claim 4 wherein said defects are cavities.

6. The structure of claim 4 wherein said waveguide is formed in said one of said planar layers by removing one of said plurality of rods.

7. The structure of claim 4 wherein said plurality of dielectric rods is comprised of alumina.

8. The structure of claim 4 wherein said material is air.

9. The structure of claim 4 wherein said first refractive index is more than 2.5 times said second refractive index.

10. The structure of claim 4 wherein said series of cavities are formed by eliminating a portion of the respective said plurality of dielectric rods.

11. The structure of claim 4 wherein said portion of the respective said plurality of dielectric rods that is eliminated is about 2.25 unit cells in length.

12. The structure of claim 4 wherein adjoining said planar layers are oriented at right angles with respect to each other.

13. The structure of claim 4 wherein electromagnetic propagation in said waveguide is single mode.

14. The structure of claim 4 further having an output port on said surface.

15. The structure of claim 14 wherein a single electromagnetic frequency is extractable from said output port.

16. The structure of claim 4 wherein said series of cavities is three in number.

17. A method for making a three dimensional photonic crystal for coupling electromagnetic radiation in or out of a waveguide comprising:
providing a waveguide passing in a first direction through said three dimensional photonic crystal structure; and
providing at least one defect arranged in a second direction substantially perpendicular to said first direction such that said at least one defect is electromagnetically coupled to said waveguide.

18. The method of claim 17 wherein electromagnetic radiation at substantially one frequency is coupled out of said waveguide.

19. The method of claim 17 wherein said at least one defect is a cavity.

20. The method of claim 17 wherein electromagnetic radiation at substantially one frequency is coupled into said waveguide.
